(19) United States
(12) Patent Application Publication
(10) Pub. No.: US 2011/0079119 A1
(43) Pub. Date: Apr. 7, 2011

(54) Screwdriver

(76) Inventors: Yu-Jyun Lee, Taichung City (TW); Yu-Hao Lee, Taichung City (TW)

(21) Appl. No.: 12/572,122

(22) Filed: Oct. 1, 2009

(51) Int. Cl. B25B 23/00; B21K 5/00

(52) U.S. Cl. 81/460; 76/119

(57) ABSTRACT

A screwdriver includes a shank and a head formed at an end of the shank. The shank is made with a diameter. The head is formed with blades. Each of the blades includes an edge. The distance between the edges of any two opposite ones of the blades is larger than the diameter of the shank.

### BACKGROUND OF INVENTION

1. Field of Invention

The present invention relates to a screwdriver and, more particularly, to a screwdriver including a shank and an enlarged head formed at an end of the shank.

2. Related Prior Art

Referring to FIG. 5, a conventional process for making a head on a shank of a screwdriver includes two steps. At A, the shank is milled with four grooves. At B, the head is finished.

Referring to FIG. 6, there is shown a first conventional screwdriver made in the conventional process. The first conventional screwdriver includes a shank 10 and a head 20 formed on the shank 10. The head 20 includes four blades 11 made by milling four grooves 12 therein. Each of blades 11 includes an edge 13 formed with a slope 14. The blades 11 converge at a tip 15. The shank 10 is made of a diameter L1. The head 20 is made of a width L2, i.e., the distance between the edges 13 of any two opposite ones of the blades 11. The diameter L1 of the shank 10 is equal to the width L2 of the head 20. An angle θ is defined between the periphery of the shank 10 and each of the slopes 14.

Referring to FIG. 7, there is shown a second conventional screwdriver made in the conventional process. The second conventional screwdriver includes a shank 10 and a head 20. The shank 10 is made of a diameter L3. The head 20 is made with a width L4. The diameter L3 of the shank 10 is equal to the width L4 of the head 20.

Referring to FIG. 8, there is shown a third conventional screwdriver made in the conventional process. The third conventional screwdriver includes a shank 10 and a head 20. The shank 10 is made of a diameter L5. The head 20 is made with a width L6. The diameter L5 of the shank 10 is equal to the width L6 of the head 20.

In the conventional screwdrivers, the diameter of the shank 10 is always equal to the width of the head 20. That is, to have a large head, we must make a wide shank in the conventional process. This could be a waste of material.

Therefore, the present invention is intended to obviate or at least alleviate the problems encountered in prior art.

### SUMMARY OF INVENTION

It is the primary objective of the present invention to provide an inexpensive screwdriver.

To achieve the foregoing objective, the screwdriver includes a shank and a head formed at an end of the shank. The shank is made with a diameter. The head is formed with blades. Each of the blades includes an edge. The distance between the edges of any two opposite ones of the blades is larger than the diameter of the shank.

Other objectives, advantages and features of the present invention will become apparent from the following description referring to the attached drawings.

### BRIEF DESCRIPTION OF DRAWINGS

The present invention will be described via detailed illustration of the preferred embodiment versus the prior art referring to the drawings.

FIG. 1 is a flow chart of a process for making screwdrivers according to the preferred embodiment of the present invention.

FIG. 2 is a side view of a first screwdriver made in the process shown in FIG. 1.

FIG. 3 is a side view of a second screwdriver made in the process shown in FIG. 1.

FIG. 4 is a side view of a third screwdriver made in the process shown in FIG. 1.

FIG. 5 is a flow chart of a conventional process for making screwdrivers.

FIG. 6 is a side view of a first conventional screwdriver made in the process shown in FIG. 5.

FIG. 7 is a side view of a second conventional screwdriver made in the process shown in FIG. 5.

FIG. 8 is a side view of a third screwdriver made in the process shown in FIG. 5.

### DETAILED DESCRIPTION OF PREFERRED EMBODIMENT

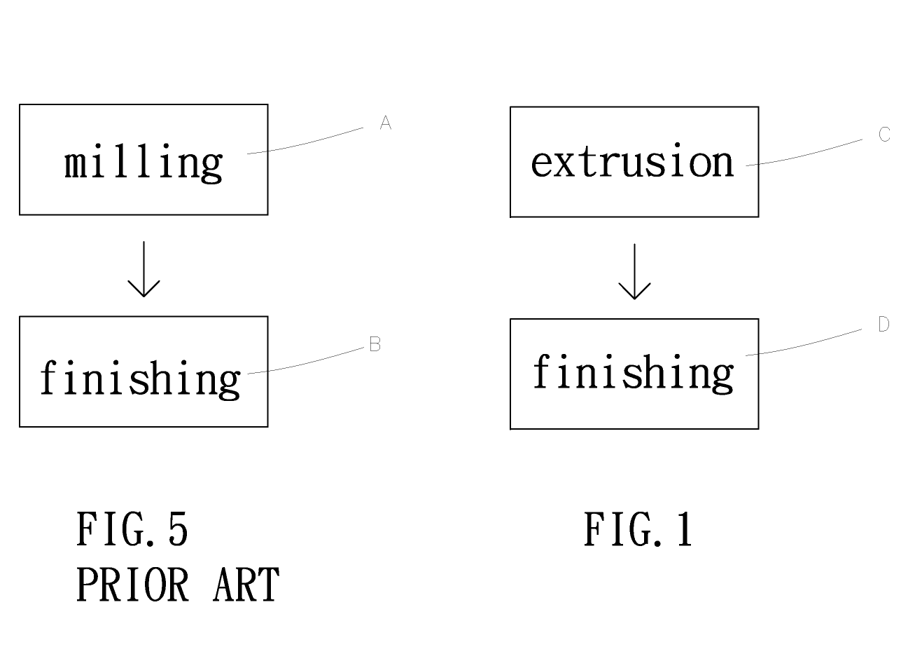

Referring to FIG. 1, there is shown a process for making screwdrivers according to the preferred embodiment of the present invention. Initially, a shank of a screwdriver is provided. The shank is made with a diameter. Then, a mold is provided. The mold includes a cavity defined therein, with a diameter larger than the diameter of the shank. At C, the free end of the shank is inserted into the mold. The shank is moved relative to the mold. Thus, the free end of the shank is made into an intended head due to extrusion. At D, the mold is removed from the head, and the screwdriver is finished.

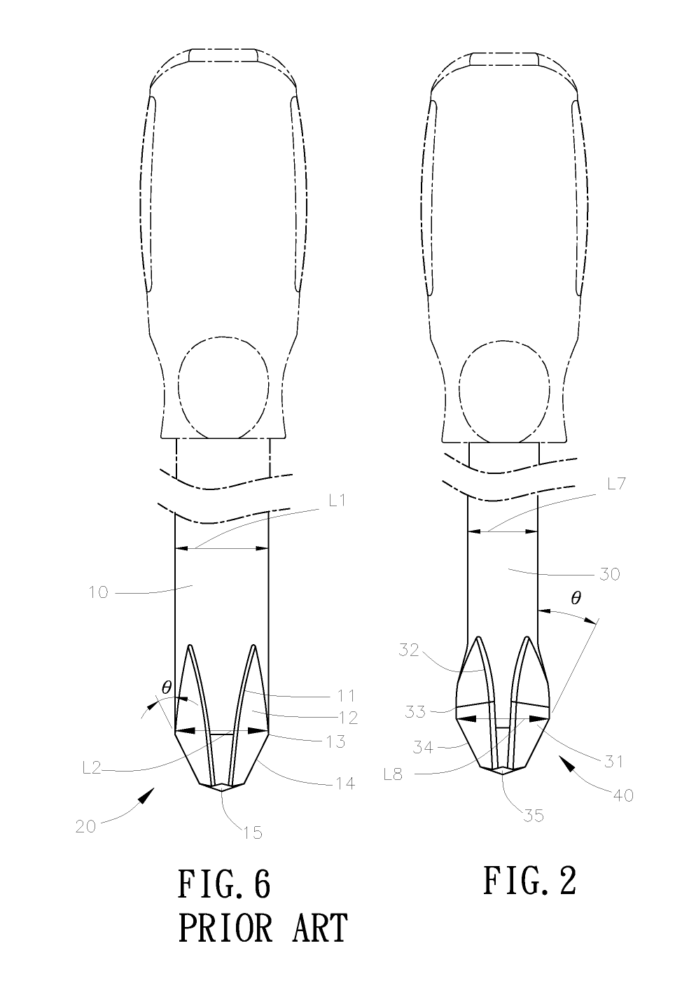

Referring to FIG. 2, there is shown a first screwdriver made in the process shown in FIG. 1. The first screwdriver includes a shank 30 and a head 40 formed on the shank 30. The head 40 includes four blades 31 made by extrusion. The blades 31 converge at a tip 35. A groove 32 is defined between any two adjacent ones of the blades 31. Each of the blades 31 includes an edge 33 formed with a slope 34. The shank 30 is made with a diameter L7. The head 40 is made with a width L8, i.e., the distance between the edges 33 of any two opposite ones of the blades 31. The diameter L7 of the shank 30 is smaller than the width L8 of the head 40. An angle θ′ is defined between the periphery of the shank 30 and each of the slopes 34.

The diameter L7 of the shank 30 is smaller than the diameter L1 of the shank 10 discussed in the RELATED PRIOR ART while the width L8 of the head 40 of the present invention is equal to the width L2 of the head 20 of the prior art.

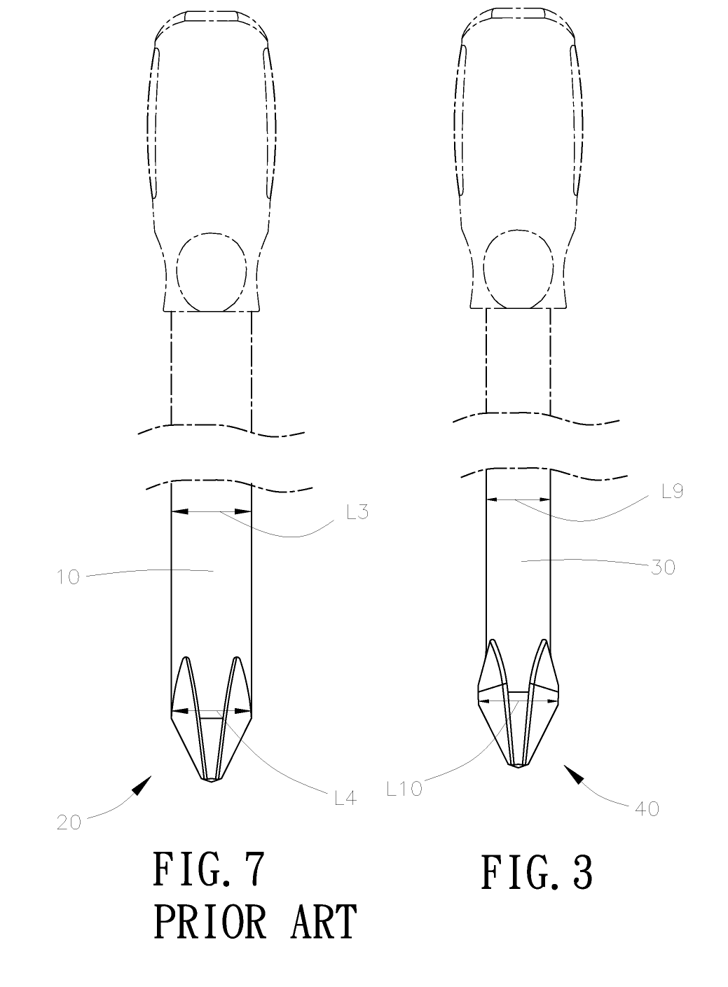

Referring to FIG. 3, there is shown a second screwdriver made in the process shown in FIG. 1. The second screwdriver includes a shank 30 and a head 40. The shank 30 is made with a diameter L9. The head 40 is made with a width L10. The diameter L9 of the shank 30 is smaller than the width L10 of the head 40.

The diameter L9 of the shank 30 of the present invention is smaller than the diameter L3 of the shank 10 of the prior art while the width L10 of the head 40 of the present invention is equal to the width L4 of the head 20 of the prior art.

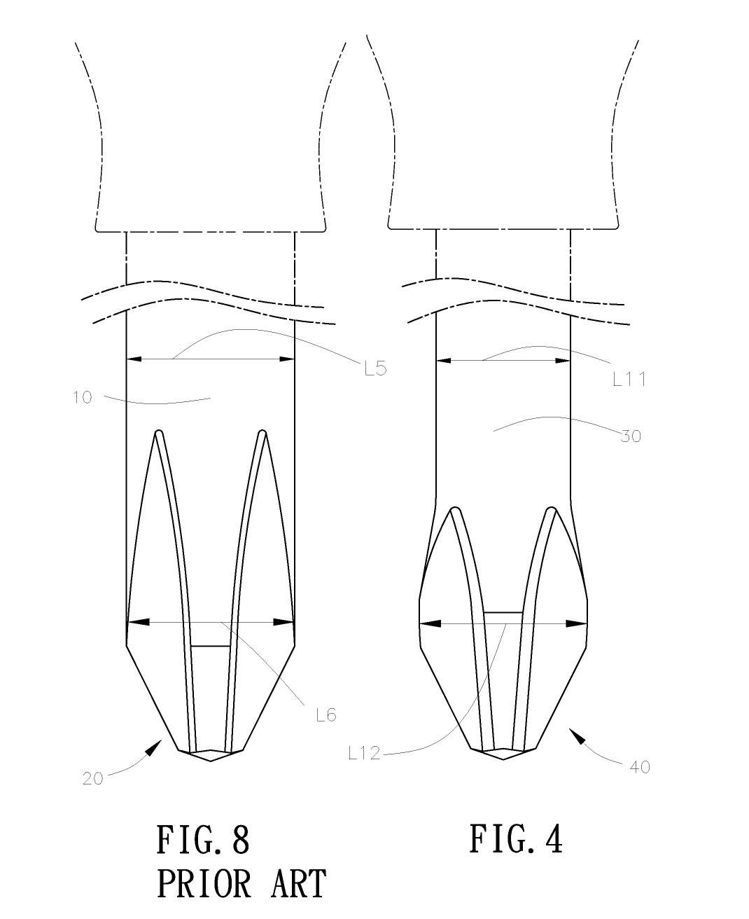

Referring to FIG. 4, there is shown a third screwdriver made in the process shown in FIG. 1. The third screwdriver includes a shank 30 and a head 40. The shank 30 is made with a diameter L11. The head 40 is made with a width L12. The diameter L11 of the shank 30 is smaller than the width L12 of the head 40.

The diameter L11 of the shank 30 of the present invention is smaller than the diameter L5 of the shank 10 of the prior art while the width L12 of the head 40 of the present invention is equal to the width L6 of the head 20 of the prior art.

Advantageously, a screwdriver of the present invention is less expensive than a counterpart screwdriver discussed in the RELATED PRIOR ART.

Furthermore, the angle θ′ between the periphery of the shank 30 and each of the slopes 34 of the present invention is larger than the angle θ between the periphery of the shank 10 and each of the slopes 14 of the prior art.

The present invention has been described through the detailed illustration of the preferred embodiment. Those skilled in the art can derive variations from the preferred embodiment without departing from the scope of the present invention. Therefore, the preferred embodiment shall not limit the scope of the present invention defined in the claims.

1. A screwdriver-making process comprising the steps of:
providing a shank with a diameter;
providing a mold with a cavity defined therein, with a diameter larger than the diameter of the shank;
partially inserting the shank into the mold; and
moving the shank towards relative to the mold so that an end of the shank is made an enlarged head due to extrusion.

2. A screwdriver comprising:
a shank made with a diameter; and
a head formed on the shank and formed with blades each comprising an edge so that the distance between the edges of any two opposite ones of the blades is larger than the diameter of the shank.

3. The screwdriver according to claim 1, wherein each of the blades comprises a slope formed at an end.
